(19) United States
(12) Patent Application Publication
(10) Pub. No.: US 2021/0008801 A1
(43) Pub. Date: Jan. 14, 2021

(54) CARRIAGES FOR 3D PRINTERS

(71) Applicant: HEWLETT-PACKARD DEVELOPMENT COMPANY, L.P., Houston,, TX (US)

(72) Inventors: Sergio DE SANTIAGO DOMINGUEZ, Sant Cugat del Valles (ES); Juan Manuel ZAMORANO, Sant Cugat del Valles (ES); Pedro GARCIA, Sant Cugat del Valles (ES)

(73) Assignee: HEWLETT-PACKARD DEVELOPMENT COMPANY, L.P., Houston, TX (US)

(21) Appl. No.: 16/088,609

(22) PCT Filed: May 10, 2017
(86) PCT No.: PCT/US2017/031943

§ 371 Date: Sep. 26, 2018

(51) Int. Cl. B29C 64/393; B29C 64/209; B29C 64/329; B29C 64/236

(52) U.S. Cl. CPC B29C 64/393; B29C 64/209; B33Y 30/00; B29C 64/236; B29C 64/329

(57) ABSTRACT

It is disclosed a system and a carriage for a 3D printing system comprising: an actuator to move the carriage; a position detection mechanism; a collision detection mechanism; and a controller. The controller to control the movement of the carriage and the controller further comprising: a memory wherein a threshold value and a detection area are stored in, the detection area comprising a set of position values of the carriage; an input to receive a position signal from the position detection mechanism and a detection signal from the collision detection mechanism; and an output to issue an alert signal if the detection signal corresponds to a distance below the threshold value and the position signal is within the detection area

### BACKGROUND

Additive manufacturing systems, commonly known as three-dimensional (3D) printers, enable objects to be generated on a layer-by-layer basis. Powder-based 3D printing systems, for example, form successive layers of a build material in a printer and selectively solidify portions of the build material to form layers of the object or objects being generated.

Some 3D printing systems may comprise carriages on which tools for handling and processing build material in different stages of the printing process are attached. These tools can be, for example, conveyors for conveying build material from a storage zone to a spreading surface, spreaders spread a dosed amount of build material over a spreading surface, nozzles to release agents on the build material, etc.

Some 3D printing systems may comprise one or several carriages and such carriages may move in the same direction or, for example, in different or orthogonal directions.

### BRIEF DESCRIPTION OF THE DRAWINGS

Examples will now be described, by way of non-limiting example only, with reference to the accompanying drawings, in which:

FIG. 1A shows an isometric view of a 3D printing system according to one example.

FIG. 1B is a plan view of the 3D printing system of FIG. 1A.

FIG. 2 is a schematic plan view showing the different areas or zones within a 3D printing system.

FIG. 3 shows a schematic of the functioning of an obstacle detection system according to one example.

FIG. 4 shows an example of flow diagram for a controller according to a first example.

### DETAILED DESCRIPTION

An example 3D printing system comprises a build unit 105 in which build material is processed in order to generate a 3D object. At least one carriage may be used to perform passes over the build surface thereby processing the build material to generate such a 3D object. An example of processing of build material to generate a 3D object may be: i) performing a first pass depositing build material on a surface thereby generating a layer of build material; ii) performing a second pass to deposit a fusing agent over, at least, portions of such layer of build material; and iii) performing a solidification pass so as to selectively heat and/or cool parts of the build material thereby solidifying such parts.

Each of such passes are performed by carriages carrying tools that may be used for spreading, heating, cooling etc. Such carriages may comprise sensitive electronics and, therefore, the 3D printing systems may comprise mechanisms that prevent the collision of carriages, either against an obstacle or against other carriages to avoid damages on the printer and, also, for the safety of the users. In the case wherein several carriages share, at least partially, a working area, the 3D printer may comprise a collision prevention mechanism on at least one of them.

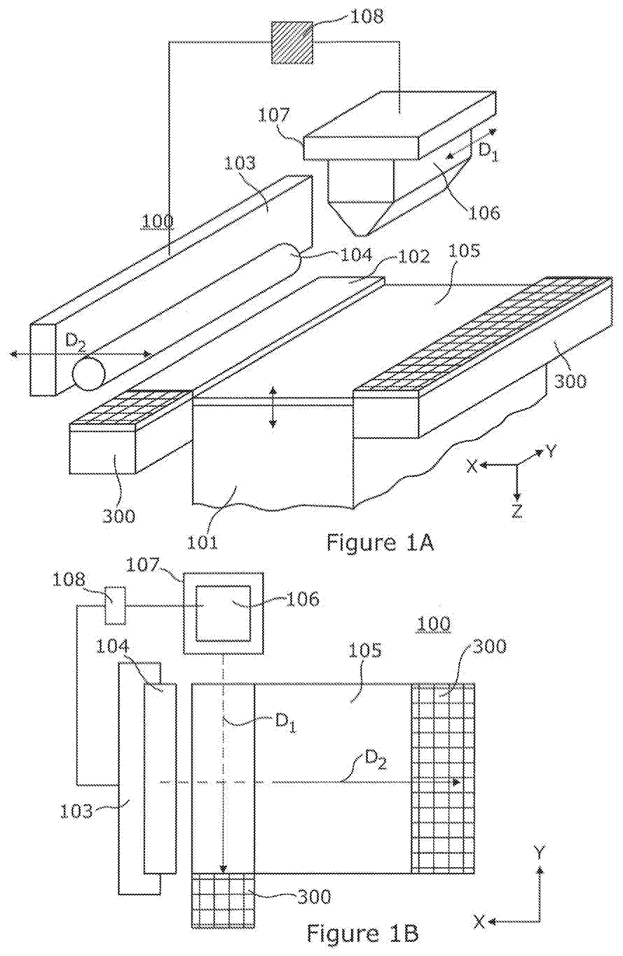

FIGS. 1A and 1B show an example of 3D printing system 100 comprising a build unit 105, an auxiliary surface 102, and recycling zones 300. The build unit 105 is a unit wherein build material is selectively solidified to generate a 3D object, the auxiliary surface 102 is a surface wherein build material is treated prior to its selective solidification, for example, for dosing. The recycling zones 300 may be located adjacent to the build or dosing surfaces so that excess build material can be treated and/or transferred to a storage for its reuse.

Also, in the examples of FIGS. 1A and 1B, there is shown a first carriage 107 comprising a hopper 106 as a tool, and a second carriage 103 comprising a spreader 104 as a tool. The first carriage 103 is configured to move in a first direction D₁, in this example, the Y axis and the second carriage 103 is configured to move along a second direction D2, in this case, the X axis. Even though, in the example of FIGS. 1A and 1B the carriages move along the orthogonal directions X and Y, the carriages may be configured to act along the same direction, e.g., one behind the other or being located at opposing sides of the build surface 105.

In an example, each of the carriages may be provided with a working area, e.g., an area wherein the carriage is active, for example, over the build surface, and a parking area, for example, an area wherein the carriage is placed on standby. This parking area may be outside the area above the build material so that a user may safely inspect and have access to such build material without the risk of being, e.g., burnt by a carriage comprising a heater as a tool. Furthermore, parking areas can be located in the vicinity of the side walls or edges, i.e., as close the edges of the printing unit as possible.

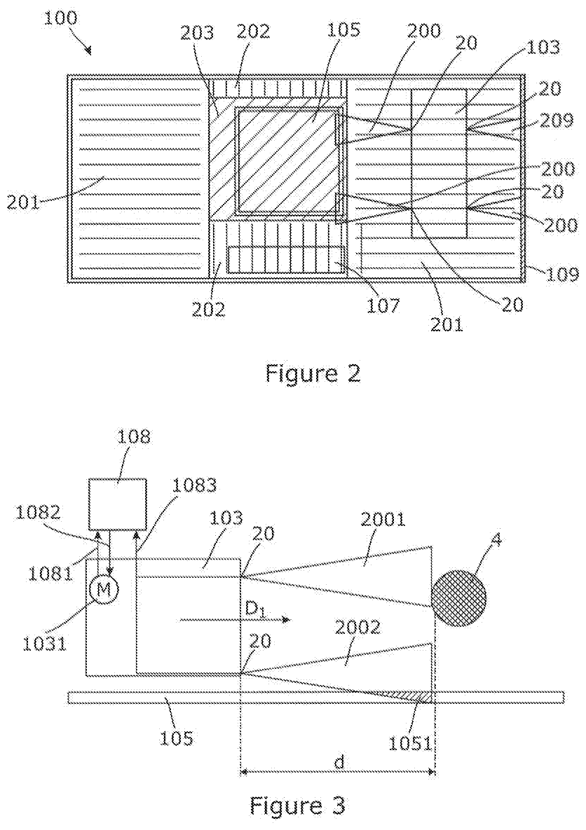

FIG. 2 shows an embodiment wherein a first carriage 107 has a working area 203 that includes the area above the build unit 105 and parking areas 202 adjacent to both sides of the working area 105 along the Y axis. In this example, a second carriage 103 has a working area 105 which is the same as the working area 105 of the first carriage, and second parking areas 201 adjacent to working area 105 along the X axis, in another example, the first and the second carriage may have different working areas that may, at least, partially overlap, in that case, it should be interpreted that the overlapping area is the working area 105.

In the example of FIG. 2, given that the carriages share a working area 105, a collision detection mechanism is provided to prevent a collision between them by detecting when a collision event may occur. Also, this collision detection system may detect obstructions other than carriages, e.g., a user Inserting external objects.

The collision detection mechanism may comprise an obstruction sensor, such as a laser 20, to issue alight beam which defines a laser range 200 wherein such laser, together with a photodetector, may be able to detect, at least, a distance with respect to an object within the obstruction sensor range 200. Other types of obstruction sensor can be: electromagnetic sensors, acoustic sensors, or mechanical switches for example.

On the other hand, the carriages may comprise an encoder or any other position sensor and a controller 108 which receives such position information.

The controller may have an input to receive a detection signal from the detection mechanism, such signal being indicative of the distance between a carriage and an object within the detection range of the obstruction sensor. Also, the controller may receive, through the same or a different input, the position information from the position sensor. Furthermore, the controller may issue an alert signal dependent on a correlation between the detection signal and the position signal, e.g., if the detection signal is within a determined range, for example, if the distance to an object Is below a distance threshold and if the carriage is located within the working area 203.

The feature of correlating the position signal and the detection signal provides the system with flexibility to define different thresholds. For example, in the controller 108, a first threshold may be set for the working area and a second threshold (or no threshold) for the parking area may be set so that the system is configured to detect an obstacle at a distance below a threshold, e.g., within 8 cm and issue and alert system if the carriage is located within the working area. On the other hand, it may be useful for the system not to issue any alert when the carriage is in the parking area as such area may, for instance, be protected by screens to avoid user Interaction and/or the carriage may be moving at a lower speed in the parking area than in the working area. Also, issuing no alert when in the parking area or, at least, issuing an alert signal if a distance is below a lower threshold, e.g., at 3 cm, allows the carriage to be positioned for parking closer to a wall 109 of the print system without issuing the alert signal. In other words, it allows to differentiate between obstacles which are extraneous objects obstructing the system in the working area, and structural parts of the 3D printing system that may be located in, or adjacent to, the parking area.

FIG. 3 shows an example wherein the collision detection mechanism comprises a laser 20 with a laser range 200, the principle of operation being that the carriage 103 also comprises a photodetector to receive the reflected signals from possible obstacles. Furthermore, a signal dependent on such reflecting signal, i.e., a detection signal 1083 may be sent to a controller 108 for further processing.

The carriage is connected to a motor 1031 and to an encoder to detect its position. The encoder may be, for example, attached to the motor 1031 and may issue a position signal 1082 which may be also be sent to the controller 108.

The controller may process the received information and, if a detection signal corresponds to a distance (d) below a predetermined threshold distance (d_{TH}) for the working area 203, and the position signal corresponds to the working area 203 an alert signal may be issued to Indicate the user or the system the presence of a possible obstacle in the working area 203 and/or act on the carriage 103 to prevent a collision. In response to such actions on the carriage, the controller may control the motor 1031 to stop the carriage 103 or reduce its speed.

In another implementation, the controller comprises a memory wherein a set of positions and a set of threshold values for some of such positions are stored. For example, the memory may comprise the positional limits of the working area and the parking area. Also, the memory may comprise a first threshold distance corresponding to the working area and a second threshold distance corresponding to the parking area.

Upon receipt of a detection signal and a position signal, the controller may determine in which area the carriage is currently positioned, i.e., the working area or the parking area, and if the detection signal is below the threshold distance for the current area, the controller may issue an alert signal.

The behavior of the carriages and the actions to be taken in the event of an alert signal may vary depending on the position of the carriage. For example, if the carriage is in the working area and an obstacle is detected, the system may respond to the alert signal issued by the controller by stopping the carriage or sending it to the parking area, whereas if the carriage is in the parking area, the controller may just slow the carriage as to prevent a strong collision.

Also, from FIG. 3 it can be seen that a carriage 103 may comprise several obstruction sensors, e.g., lasers 20. Such sensors may comprise a detection range, such as, a first sensor range 2001 and a second sensor range 2002. In the case wherein the sensors are located in the lower half of the carriage 103 noise may be detected by the sensor in the second laser range 2002 due to a section of build material 1051, such noise may be highly reflective thereby causing malfunctioning the system by issued false positives, i.e., erroneous detections of obstacles 4.

Therefore, it Is advantageous to have the obstruction sensors located in the upper half of the carriage and, preferable, in the vicinity of the top surface of the carriage.

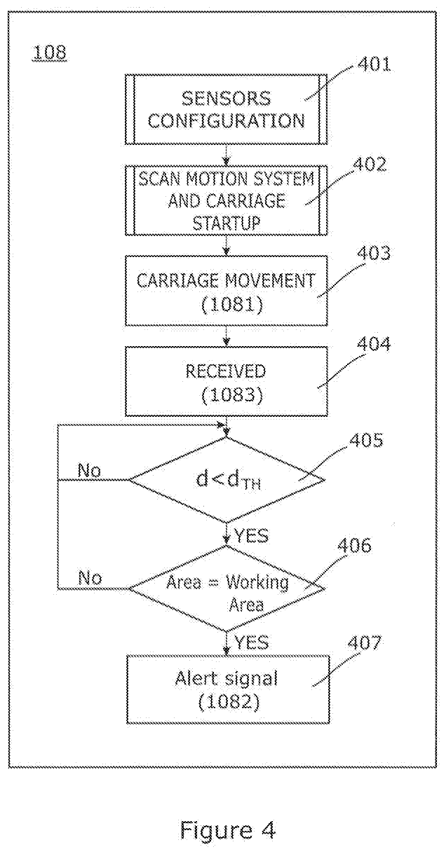

FIG. 4 shows a flow diagram wherein an example of operation of the controller 108 is disclosed.

In a first configuration routine 401 the controller 108 may set up the sensors for their calibration and determine if they are operable. In a second configuration routine 402, the controller 108 performs a scan motion that may comprise a run along at least part of the working area 203 or the parking area 201 and calibrate the position sensors.

Upon operation of the 3D printing system 100 the carriage may move along a direction and, by means of a position sensor such as an encoder, a position signal 1081 is received 403 by the controller 108. Also, the obstruction sensors may be active so as to detect possible obstacles in the moving direction. In step 404, a signal is received that reflects a distance (d) between the carriage and an obstacle 4 such as another carriage. Subsequently, the controller 108 performs a first comparison 405 to determine if the distance is smaller than the threshold distance d_{TH}, i.e., the safety distance. Also, the controller 108 may determine, by the position signal received, in view of the carriage movement 403, the area in which the carriage is located. In a second comparison step 406, it is determined if the carriage is within, e.g., the working area and, if the distance is lower than the threshold distance di that corresponds to such working area, the controller may issue 407 an alert signal 1082.

In essence, it is disclosed a 3D printing system comprising:
a first carriage comprising a first tool and adapted to move between a working area and a first parking area;
a second carriage comprising a second tool and adapted to move between the working area and a second parking area;
a collision detection mechanism attached to at least the first carriage to issue a detection signal dependent on the distance between the first carriage and an obstacle;
a position detection mechanism to detect the position of the first carriage and issue a corresponding position signal;
   the system further comprising a controller connected to the collision detection mechanism and the position detection mechanism to receive the detection signal and the positioning signal and to issue an alert signal if the detection signal corresponds to a distance below a threshold value and the position signal corresponds to a position of the carriage in the working area.

In an example, the controller may be provided with a second threshold value lower than the threshold value and wherein the controller issues the alert signal if the detection signal corresponds to a distance below the second threshold value and the first carriage is in the parking area.

Also, the tools may comprise at least one of: a nozzle, a print head, a spreader, a hopper, or a heat generator.

In an example, the obstacle may be the second carriage, so the system may be provided to prevent a crash between the first and the second carriages. Therefore, the alert signal issued by the controller may be used to reduce or increase the speed of the first carriage depending on detection signal, i.e., If there is no obstacle the speed can be increased, and if an obstacle is detected the speed may be lowered. Also, the alert signal may comprise a stop signal to at least the first carriage and/or the second carriage

Also, it is contemplated that the first and second parking areas may be at least partly coincident.

Regarding the threshold value (or values) they may be a predetermined value or a value selectable by a user. In an example, the threshold values may be dynamically modified by the system in view, e.g., of the printing process.

Also, it is disclosed a carriage for a 3D printing system comprising
an actuator to move the carriage;
a position detection mechanism;
a collision detection mechanism; and
a controller;
   wherein the controller controls the movement of the carriage, and wherein the controller further comprises:
a memory wherein a threshold value and a detection area are stored, the detection area further comprising a set of position values of the carriage;
an input to receive a position signal from the position detection mechanism and a detection signal from the collision detection mechanism; and
an output to issue an alert signal if the detection signal corresponds to a distance below the threshold value and the position signal is within the detection area.

In an example, the set of values comprise at least a set of values that correspond to the positional limits of the detection area.

Also, the alert signal may comprise a signal to stop the movement of the actuator or, at least decrease its speed.

Furthermore, the controller may comprise at least two threshold values for at least two detection areas wherein the controller is to determine if the carriage is in one of the areas and if the detection signal corresponds to a distance below the threshold value for such area.

In an example, the position detection mechanism is an encoder and the collision detection mechanism may comprise e.g., a laser and a photodetector.

1. 3D printing system comprising:
a first carriage comprising a first tool and adapted to move between a working area and a first parking area;
a second carriage comprising a second tool and adapted to move between the working area and a second parking area;
a collision detection mechanism attached to at least the first carriage to Issue a detection signal dependent on the distance between the first carriage and an obstacle;
a position detection mechanism to detect the position of the first carriage and issue a corresponding position signal;
the system further comprising a controller connected to the collision detection mechanism and the position detection mechanism to receive the detection signal and the positioning signal and to issue an alert signal if the detection signal corresponds to a distance below a threshold value and the position signal corresponds to a position of the carriage in the working area.

2. The 3D printing system according to claim 1 wherein the system comprises a second threshold value lower than the threshold value and wherein the controller issues the alert signal if the detection signal corresponds to a distance below the second threshold value and the first carriage is in the parking area.

3. The 3D printing system according to claim 1 wherein the tools comprise at least one of: a nozzle, a print head, a spreader, a hopper, or a heat generator.

4. The 3D printing system, according to claim 1, wherein the obstacle is the second carriage.

5. The 3D printing system, according to claim 4 wherein the controller reduces or increases the speed of the first carriage depending on detection signal.

6. The 3D printing system, according to claim 1 wherein the first and the second parking area are at least partly coincident.

7. The 3D printing system, according to claim 1, wherein the alert signal comprises a stop signal to at least the first carriage and/or the second carriage.

8. The 3D printing system, according to claim 1, wherein the threshold value is a predetermined value.

9. The 3D printing system, according to claim 1, wherein the threshold value is a value selectable by a user.

10. A carriage for a 3D printing system comprising
an actuator to move the carriage;
a position detection mechanism;
a collision detection mechanism; and
a controller:
wherein the controller controls the movement of the carriage, and wherein the controller further comprises:
a memory wherein a threshold value and a detection area are stored, the detection area further comprising a set of position values of the carriage;
an input to receive a position signal from the position detection mechanism and a detection signal from the collision detection mechanism; and
an output to issue an alert signal if the detection signal corresponds to a distance below the threshold value and the position signal is within the detection area.

11. The carriage, according to claim 10, wherein the set of values comprise at least a set of values that correspond to the positional limits of the detection area.

12. The carriage, according to claim 10, wherein the alert signal comprises a signal to stop the movement of the actuator.

13. The carriage, according to claim 10, wherein the controller comprises at least two threshold values for at least two detection areas wherein the controller is to determine if the carriage is in one of the areas and if the detection signal corresponds to a distance below the threshold value for such area.

14. The carriage, according to claim 10 wherein the position detection mechanism is an encoder.

15. The carriage, according to claim 10, wherein the collision detection mechanism comprises a laser and a photodetector.
